(19) United States
(12) Patent Application Publication
(10) Pub. No.: US 2006/0081698 A1
(43) Pub. Date: Apr. 20, 2006

(54) Electronic settlement system

(75) Inventor: Junichi Yamagishi, Higashi- Nihonbashi (JP)

Correspondence Address: JORDAN AND HAMBURG LLP, 122 EAST 42ND STREET, SUITE 4000, NEW YORK, NY, 10168, US

(73) Assignee: Nihon Unica Corporation, Chuo-ku (JP)

(21) Appl. No.: 11/255,225

(22) Filed: Oct. 19, 2005

(30) Foreign Application Priority Data
Oct. 20, 2004 (JP) 2004-305219

(51) Int. Cl. G07F 19/00

(52) U.S. Cl. 235/379

(57) ABSTRACT

An electronic settlement system includes a plurality of reader-writers, a controller, and a wireless communication circuit to connect the reader-writers to the controller. The controller includes an authentication module to authenticate an IC chip brought into a read area of any one of the reader-writers. The system has no need to providing each of the reader-writers with an IC chip authentication module. Also not needed are wires to connect the reader-writers to the controller. Accordingly, the electronic settlement system is realizable at low cost even if the system involves a plurality of reader-writers.

### BACKGROUND OF THE INVENTION

1. Field of the Invention

The present invention relates to an electronic settlement system employing an IC chip that stores monetary data such as electronic money.

2. Description of Related Art

An electronic settlement system employs a card-like medium or portable terminal having an IC chip that holds monetary data such as electronic money to settle accounts. An example of such a system is disclosed in Japanese Unexamined Patent Application Publication No. 2002-74473. According to the electronic settlement system of the related art, a user makes a reader-writer read the monetary data stored in the IC chip, thereby simply settling accounts.

The reader-writer of the related art incorporates an authentication module that authenticates the IC chip or user at the time of settlement. The reader-writer is connected through a line to a controller installed on a system management side, and the controller collects data related to transactions conducted by the reader-writer.

When the electronic settlement system is applied to, for example, an amusement facility or a supermarket, there are arranged a plurality of reader-writers each with an authentication module. Each reader-writer must have a line to connect the reader-writer to the controller of the system management side. The authentication module and connection line that must be prepared for each reader-writer increase cost when the conventional electronic settlement system is applied to a location where a plurality of reader-writers are needed.

### SUMMARY OF THE INVENTION

An object of the present invention is to provide an electronic settlement system that is realizable at low cost even if applied to a location that needs a plurality of reader-writers.

In order to accomplish the object, an aspect of the present invention provides an electronic settlement system including a plurality of reader-writers, a controller, and a wireless communication circuit to connect the reader-writers to the controller. The controller authenticates a storage medium that is brought close to or is inserted into any one of the reader-writers.

The electronic settlement system of this aspect has no need of providing each reader-writer with an authentication module and a line to connect the reader-writer to the controller. Accordingly, the electronic settlement system is achievable at low cost for a location that needs a plurality of reader-writers.

### BRIEF DESCRIPTION OF THE DRAWINGS

FIG. 1 is a general view showing an electronic settlement system according to an embodiment of the present invention;

FIG. 2 is a block diagram showing the details of a master wireless unit in the system of FIG. 1; and

FIG. 3 is a block diagram showing the details of a controller in the system of FIG. 1.

### DETAILED DESCRIPTION OF EMBODIMENTS

An electronic settlement system according to an embodiment of the present invention will be explained. In this embodiment, the electronic settlement system is applied to an amusement facility in which a plurality of game machines are installed. Each game machine is playable with electronic money stored in an IC chip. According to the embodiment, a user who wants to play a game machine must insert cash, a cash card, a credit card, or the like into a money input machine that deposits electronic money into an IC chip. The IC chip is of a noncontact type in this embodiment. The IC chip may be of a contact type.

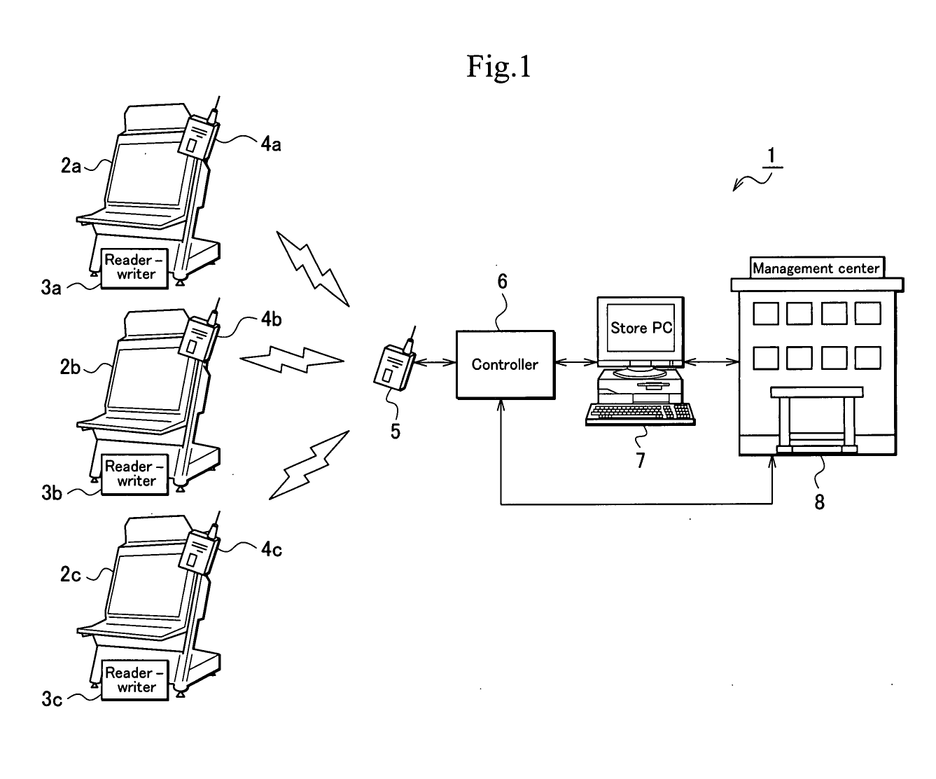

FIG. 1 shows the electronic settlement system 1 according to the embodiment. The system 1 includes a plurality of game machines 2a, 2b, and 2c, reader-writers 3a, 3b, and 3c provided for the game machines 2a, 2b, and 2c, respectively, slave wireless units 4a, 4b, and 4c provided for the reader-writers 3a, 3b, and 3c, respectively, a master wireless unit 5 wirelessly connected to the slave wireless units 4a, 4b, and 4c, a controller 6 connected through a line to the master wireless unit 5, a store PC (personal computer) 7 connected through a line to the controller 6, and a management center unit 8.

Each of the reader-writers 3a, 3b, and 3c has an antenna, a read/write part, and a control part. The antenna is used to wirelessly communicate with an IC chip brought into a read area of the reader-writer. With the antenna, the reader-writer reads and rewrites electronic money stored in the IC chip. The control part controls operation of the corresponding game machine according to a result of a process carried out by the read/write part.

Each of the reader-writers 3a, 3b, and 3c reads and rewrites electronic money stored in an IC chip brought into an operation area of the reader-writer and controls operation of the corresponding game machine based on the electronic money stored in the IC chip.

In addition to the antenna, read/write part, and control part, each of the reader-writers 3a, 3b, and 3c has a liquid crystal display to display various information pieces such as the balance of electronic money stored in the IC chip, as well as LEDs (light emitting diodes) to indicate the processing state of the read/write part.

The slave wireless units 4a, 4b, and 4c employ a wireless communication method such as IEEE 802.11a/b/g to carry out wireless communication with the reader-writers 3a, 3b, and 3c and the master wireless unit 5.

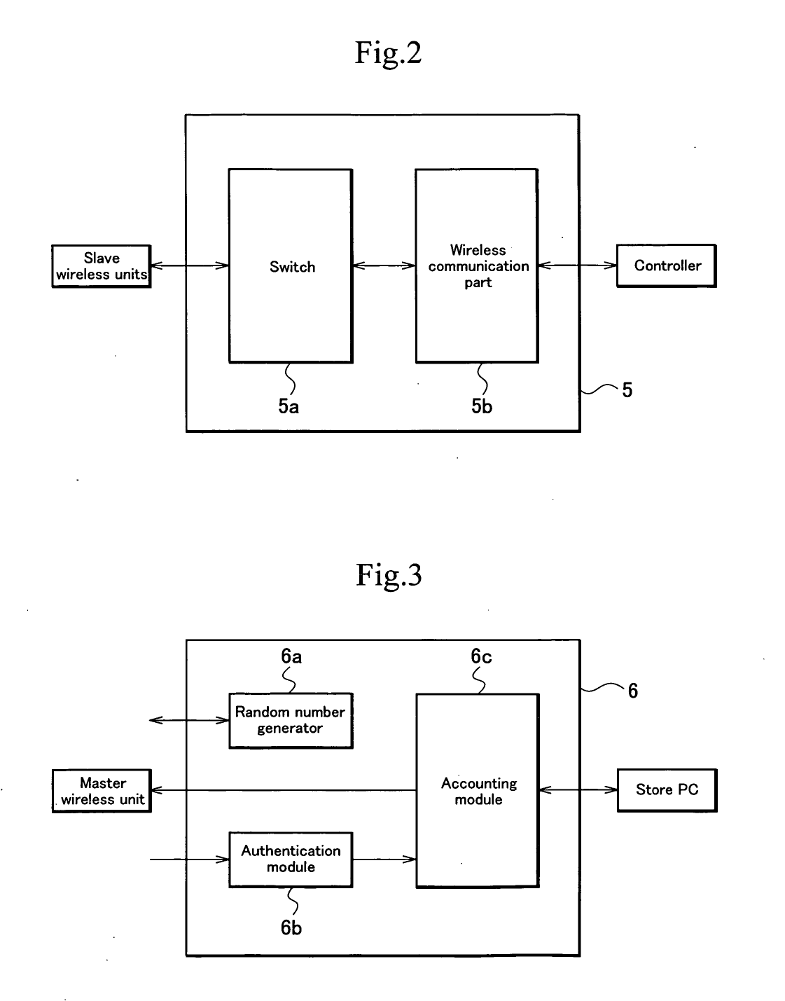

The master wireless unit 5 employs the same wireless communication method as that employed by the wireless slave units 4a, 4b, and 4c, to carry out wireless communication. As shown in FIG. 2, the master wireless unit 5 has a switch 5a and a wireless communication part 5b and is selectively wirelessly connected to the slave wireless units 4a, 4b, and 4c. Namely, the switch 5a of the master wireless unit 5 is controlled in response to a control signal from the controller 6, to connect the master wireless unit 5 to one of the slave wireless units 4a, 4b, and 4c. The connected slave wireless unit and the controller 6 conduct wireless communication via the wireless communication part 5b of the master wireless unit 5.

FIG. 3 shows the details of the controller 6. In FIG. 3, the controller 6 has a random number generator 6a, an authentication module 6b, and an accounting module 6c. The random number generator 6a generates a random number that is used to switch the slave wireless unit wirelessly connected to the master wireless unit 5 to another. The authentication module 6b authenticates an IC chip by checking to see if the IC chip is valid or has electronic money or the like. When authenticating an IC chip, the authentication module 6b may ask the user of the IC chip to enter a password or biometric data, to carry out personal identification as well. The accounting module 6c controls read and rewrite operations of electronic money stored in the IC chip.

As mentioned above, the random number generator 6a generates a random number, and the controller 6 sends a control signal corresponding to the random number to the master wireless unit 5. According to the control signal, the master wireless unit 5 selects one of the slave wireless units to be connected thereto. Then, the authentication module 6b of the controller 6 authenticates an IC chip that is brought into a read area of the reader-writer corresponding to the connected slave wireless unit. If the IC chip is authenticated, the accounting module 6c conducts to read and rewrite electronic money stored in the authenticated IC chip according to a charge for playing the game machine connected to the reader-writer. The controller 6 may be wirelessly connected to the master wireless unit 5.

The store PC 7 may be a general-purpose information processing unit. The store PC 7 communicates with the controller 6 to receive therefrom data about each game machine, IC chip authentication results, data related to the use of the money input machine, sales data, and the like. The store PC 7 may be wirelessly connected to the controller 6.

The management center unit 8 may be a general-purpose information processing unit such as a workstation and is connected through electric communication circuits to the controller 6 and store PC 7. The management center unit 8 communicates with the controller 6 and store PC 7 through the electric communication circuits and obtains therefrom data about each game machine, IC chip authentication results, data related to the use of the money input machine, sales data, and the like.

According to the electronic settlement system 1 of this embodiment, the reader-writer of any one of the game machines 2a, 2b, and 2c reads data from an IC chip brought into a read area of the antenna of the reader-writer. The read data is wirelessly transmitted from a corresponding one of the slave wireless units 4a, 4b, and 4c to the master wireless unit 5.

The master wireless unit 5 switches the slave wireless units 4a, 4b, and 4c to be connected to the master wireless unit 5 from one to another according to a random number provided by the random number generator 6a of the controller 6. When the slave wireless unit that transmits data read out of an IC chip is connected to the master wireless unit 5, the controller 6 obtains the data.

According to the obtained IC chip data, the authentication module 6b of the controller 6 authenticates the IC chip. If the IC chip is successfully authenticated, the accounting module 6c of the controller 6 rewrites through a corresponding one of the reader-writers 3a, 3b, and 3c electronic money stored in the IC chip. Namely, the accounting module 6b subtracts a charge for playing a corresponding one of the game machines 2a, 2b, and 2c from the electronic money stored in the IC chip through the corresponding reader-writer. The balance after the subtraction is sent with an operation control signal through the maser and slave wireless units to the reader-writer. According to the operation control signal, the reader-writer rewrites the electronic money stored in the IC chip.

When conducting the rewrite operation, the reader-writer may start the game machine according to an amount of the subtracted electronic money. The game machines 2a, 2b, and 2c may be operated according to operation control signals sent from the controller 6.

Data about each game machine, IC chip authentication results, data related to the use of the money input machine, sales data, and the like are stored or updated in the controller 6. These data pieces are obtainable, usable, and confirmable at the store PC 7 and management center unit 8.

As explained above, the electronic settlement system 1 according to this embodiment of the present invention includes the reader-writers 3a, 3b, and 3c provided for the game machines 2a, 2b, and 2c, respectively, to read and rewrite electronic money stored in IC chips. The game machines are playable with the electronic money stored in the IC chips. The system 1 also has the controller 6 to control operation of the reader-writers 3a, 3b, and 3c that are connected through a wireless communication circuit to the controller 6. The controller 6 authenticates, through the wireless communication circuit, an IC chip brought into a read area of any one of the reader-writers 3a, 3b, and 3c.

In the electronic settlement system 1 according to the embodiment, the reader-writers 3a, 3b, and 3c are connected through the wireless communication circuit to the controller 6, and the authentication module 6b of the controller 6 authenticates an IC chip brought into a read area of any one of the reader-writers 3a, 3b, and 3c. The embodiment has no need of providing each of the reader-writers 3a, 3b, and 3c with an IC chip authentication module. Accordingly, the system 1 involving a plurality of reader-writers has a simple structure and is realizable at low cost. Even if the amusement facility employing the electronic settlement system 1 introduces new game machines, the system 1 can easily cope with them.

The system 1 according to the embodiment has no need of preparing wires to connect the reader-writers 3a, 3b, and 3c to the controller 6. This results in simplifying the structure of the system 1, reducing the cost thereof, and allowing the system 1 to easily cope with new game machines to be introduced into an amusement facility for which the system 1 operates.

The controller 6 controls operations of the reader-writers 3a, 3b, and 3c through wireless communication, to reduce the cost of the system 1 and simplify the structure thereof. Data related to the control operations conducted by the controller 6 may be recorded, so that data of each game machine may be recorded and updated on the controller 6 side.

Although the present invention has been explained with reference to the embodiments, it must be understood that the embodiments, descriptions, and drawings disclosed herein are not intended to limit the present invention and that other embodiments, modifications, or implementations that may occur to persons skilled in the art from the teachings of the present invention also fall in the scope of the present invention.

What is claimed is:

1. An electronic settlement system comprising:
a reader-writer provided for each of a plurality of terminal units which monetary data stored in a storage medium is used, the reader-writer being configured to read and rewrite the monetary data stored in the storage medium when the storage medium is brought into a read area of the reader-writer; and
a controller connected to the reader-writers through a wireless communication circuit and configured to control the read and rewrite operations of the reader-writers and authenticate, through the wireless communication circuit, the storage medium when the storage medium is brought into the read area of any one of the reader-writers.

2. The system of claim 1, wherein:
the controller has a switch configured to switch one of the reader-writers connected through the wireless communication circuit to the controller to another.

3. The system of claim 2, wherein:
the controller further has a random number generator configured to generate a random number; and
the controller controls the switch according to the random number to switch one of the reader-writers connected through the wireless communication circuit to the controller to another.

4. The system of claim 1, wherein:
the storage medium is an IC chip.

5. The system of claim 2, wherein:
the storage medium is an IC chip.

6. The system of claim 3, wherein:
the storage medium is an IC chip.
